(19) United States
(12) Patent Application Publication
(10) Pub. No.: US 2024/0034231 A1
(43) Pub. Date: Feb. 1, 2024

(54) AUDIO REPRODUCTION DEVICE AND AUDIO REPRODUCTION METHOD

(71) Applicant: LAPIS Technology Co., Ltd., Yokohama (JP)

(72) Inventor: Kazushige MATSUURA, Yokohama (JP)

(73) Assignee: LAPIS Technology Co., Ltd., Yokohama (JP)

(21) Appl. No.: 18/356,195

(22) Filed: Jul. 20, 2023

(30) Foreign Application Priority Data
Jul. 29, 2022 (JP) 2022-121623

(51) Int. Cl. B60Q 5/00

(52) U.S. Cl. CPC B60Q 5/008

(57) ABSTRACT

An audio reproduction device and method are provided. The audio reproduction device is connected to an external memory storing audio data series respectively corresponding to audio phrases and storing management information indicating an address at which each of the plurality of audio data series is stored, and perform reproduction of audio by reading the audio data series from the external memory for each audio phrase. The audio reproduction device includes a serial interface performing serial communication, registers storing the management information corresponding to the audio data series of at least two audio phrases transmitted from the external memory via the serial interface, and a reproduction control circuit reading the audio data series from the external memory via the serial interface for each audio phrase based on the management information stored in the registers and reproducing audio in the order of reading the audio data series for each audio phrase.

### CROSS-REFERENCE TO RELATED APPLICATION

This application claims the priority benefits of Japanese application no. 2022-121623, filed on Jul. 29, 2022. The entirety of the above-mentioned patent application is hereby incorporated by reference herein and made a part of this specification.

### BACKGROUND

### Technical Field

The disclosure relates to an audio reproduction device and an audio reproduction method.

### Description of Related Art

Regarding electric vehicles or electric hybrid vehicles traveling by means of an electric motor, since they make extremely less noise than engined cars at the time of low-speed traveling, vehicles equipped with a vehicle approach notification device that generates a sound for informing the outside of the vehicle of approach of a host vehicle (which will hereinafter be referred to as a vehicle approach sound) are commercialized. When the vehicle is traveling at a speed lower than a predetermined speed, the vehicle approach notification device changes a timbre of the vehicle approach sound in response to a traveling velocity thereof.

Regarding such a vehicle approach notification device, a device including a memory in which a plurality of pieces of timbre generation data having timbres different from each other is stored in advance in association with traveling velocities of a vehicle in advance has been proposed (for example, refer to Patent Document 1).

In the vehicle approach notification device, first, a timbre generation data piece indicating a synthesized sound corresponding to a current traveling velocity of the vehicle is read from the memory. Further, the vehicle approach notification device converts a combination of timbre generation data pieces which have been sequentially read from the memory into an analog audio signal and acoustically outputs this to the outside of the vehicle through a speaker.

### PATENT DOCUMENTS

[Patent Document 1] Japanese Patent Laid-Open No. 2011-207390

For example, a notification device as described above is constituted of an audio reproduction LSI outputting audio and a host microcomputer controlling the audio reproduction LSI. When a memory is not built into the audio reproduction LSI, for example, a memory such as a serial flash memory is connected thereto, and audio data is acquired from the outside. The serial flash memory stores a plurality of audio data series respectively corresponding to a plurality of audio phrases, and phrase management information indicating a start address and an end address (that is, addresses of storage domains inside the memory) of the audio data series for each audio phrase.

The audio reproduction LSI first reads the phrase management information from the serial flash memory via a serial interface and then starts reproduction of audio by reading the audio data from the serial flash memory using information of the start address indicated in the phrase management information. Further, the audio reproduction LSI performs reproduction of audio in the order of reading by reading the audio data series for each sampling frequency, and when processing reaches the end address and reading and reproduction of the corresponding audio data are performed, audio reproduction processing of the audio phrase thereof ends.

However, in an audio reproduction LSI having the foregoing constitution, since there is a need to read the phrase management information corresponding to the audio phrase every time reading of the audio data series for each audio phrase and reproduction of audio are performed, there is a problem that audio of a plurality of audio phrases cannot be continuously reproduced. For example, when the sampling frequency is high and a time interval of reading the audio data series is short, the phrase management information corresponding to a next audio phrase may not be able to be read during a period from when last reading of the audio data series of one audio phrase ends until when first reading of the audio data series of the next audio phrase starts. For this reason, there is a problem that continuous reproduction of audio of a plurality of audio phrases cannot be smoothly performed.

The disclosure provides an audio reproduction device capable of smoothly performing continuous reproduction of audio of a plurality of audio phrases.

### SUMMARY

An audio reproduction device according to the disclosure is an audio reproduction device that is connected to an external memory storing a plurality of audio data series respectively corresponding to a plurality of audio phrases and storing management information indicating an address at which each of the plurality of audio data series is stored, and performs reproduction of audio by reading the audio data series from the external memory for each audio phrase. The audio reproduction device includes a serial interface performing serial communication with the external memory, registers storing the management information corresponding to the audio data series of at least two of the audio phrases transmitted from the external memory via the serial interface, and a reproduction control circuit reading the audio data series from the external memory via the serial interface for each audio phrase on the basis of the management information stored in the registers and reproducing audio in the order of reading the audio data series for each audio phrase.

An audio reproduction method according to the disclosure is an audio reproduction method executed by an audio reproduction device that is connected to an external memory storing a plurality of audio data series respectively corresponding to a plurality of audio phrases and storing management information indicating an address at which each of the plurality of audio data series is stored; and includes a serial interface performing serial communication with the external memory, registers storing data transmitted from the external memory via the serial interface, and a reproduction control circuit reading the audio data from the external memory via the serial interface for each audio phrase and reproducing audio in the order of reading the audio data for each audio phrase. The audio reproduction method includes a step of reading the management information corresponding to the audio data series of at least two of the audio phrases from the external memory via the serial interface, a step of storing the management information corresponding to the audio data series of at least the two or more of the audio phrases read from the external memory in the registers, a step of reading the audio data series from the external memory via the serial interface for each audio phrase on the basis of the management information stored in the registers, and a step of reproducing audio on the basis of the order of reading the audio data series for each audio phrase.

### BRIEF DESCRIPTION OF THE DRAWINGS

FIG. 1 is a block diagram showing a constitution of a vehicle approach notification system.

FIG. 2 is a block diagram showing an internal constitution of an audio reproduction device of Example 1.

FIG. 3 is a view showing an example of data stored in an external memory.

FIG. 4 is a block diagram showing an example of phrase management information stored in a register.

FIG. 5 is a view schematically showing operation of reading the phrase management information.

FIG. 6 is a view schematically showing operation of reading audio data.

FIG. 7 is a block diagram showing an internal constitution of an audio reproduction device of a comparative example.

FIG. 8 is a view schematically showing operation of reading audio data of the comparative example.

FIG. 9 is a view schematically showing operation when phrases are continuously read in the comparative example.

### DESCRIPTION OF THE EMBODIMENT

According to the audio reproduction device of the disclosure, continuous reproduction of audio of a plurality of audio phrases can be smoothly performed.

Preferred examples of the disclosure will be described below in detail. In description and the accompanying drawings of the following examples, the same reference signs are applied to parts which are substantially the same or equivalent.

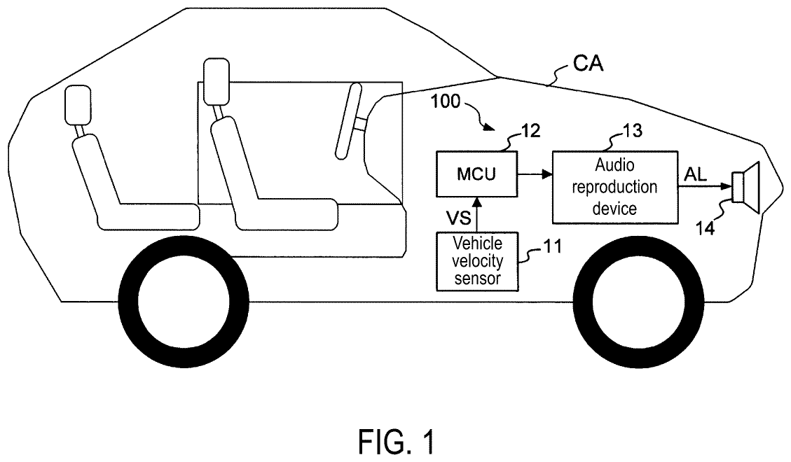

FIG. 1 is a block diagram showing a constitution of a vehicle approach notification system 100 according to the disclosure. The vehicle approach notification system 100 is an audio outputting system mounted in a vehicle CA and issues notification of approach of the vehicle CA by outputting audio corresponding to a traveling velocity of the vehicle CA (that is, a vehicle velocity).

The vehicle approach notification system 100 has a vehicle velocity sensor 11, an MCU 12, an audio reproduction device 13, and a speaker 14.

The vehicle velocity sensor 11 detects the traveling velocity of the vehicle CA and supplies a velocity signal VS indicating information of the traveling velocity to the MCU 12.

The micro controller unit (MCU) 12 is a host microcomputer controlling audio reproduction operation by the audio reproduction device 13. The MCU 12 controls the audio reproduction device 13 on the basis of the velocity signal VS and reproduces a vehicle approach sound having a pitch and a volume corresponding to the traveling velocity of the vehicle CA.

The audio reproduction device 13 generates a vehicle approach sound signal AL corresponding to the traveling velocity of the vehicle CA in response to control of the MCU 12 and supplies it to the speaker 14.

For example, the speaker 14 is installed in a front bumper of the vehicle CA and emits an audible sound based on the vehicle approach sound signal AL as a vehicle approach sound AS to a space outside the vehicle CA.

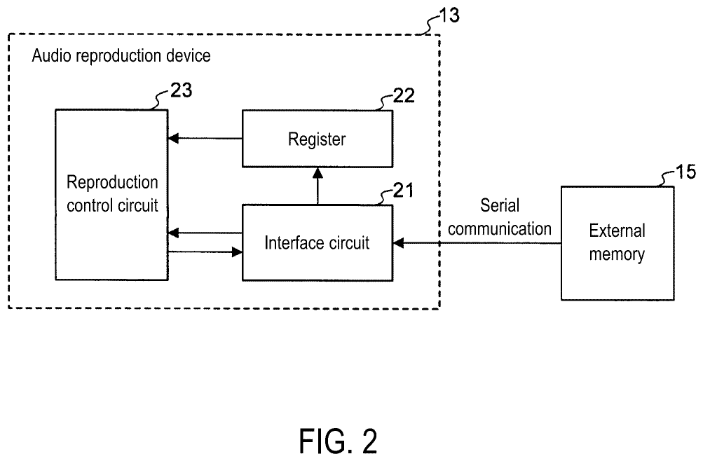

FIG. 2 is a block diagram showing an internal constitution of the audio reproduction device 13. Here, illustration of the vehicle velocity sensor 11, the MCU 12, and the speaker 14 is omitted.

The audio reproduction device 13 reproduces audio by reading audio data series for each audio phrase from an external memory 15 connected to the outside.

The external memory 15 is a non-volatile semiconductor memory and is constituted of a NAND or NOR serial flash memory, for example. The external memory 15 stores audio data of a plurality of audio phrases corresponding to the traveling velocities of the vehicle CA. Each piece of the audio data of each audio phrase is constituted of a serial audio data group (in other words, audio data series). In addition, the external memory 15 stores phrase management information including addresses indicating domains in which the audio data series are stored inside the memory.

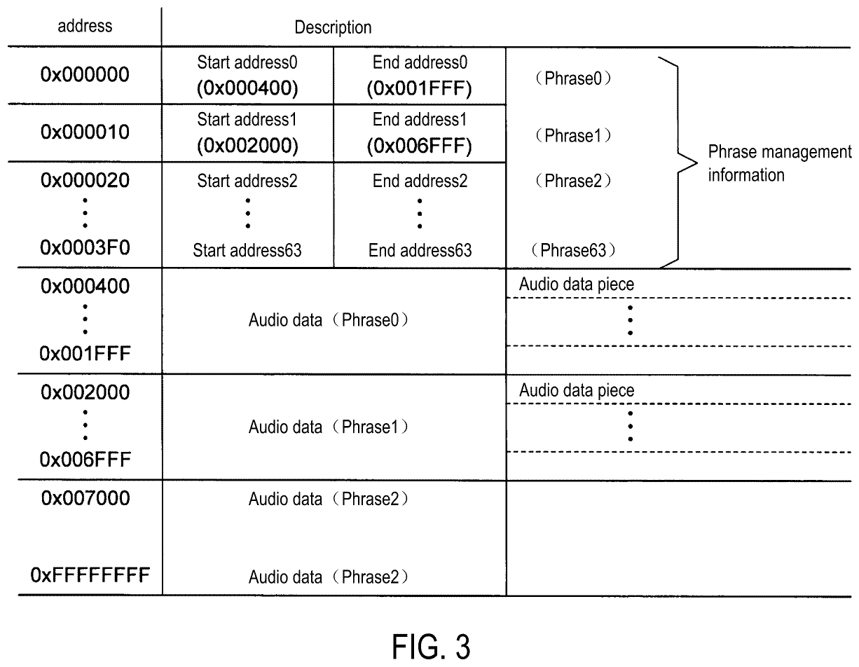

FIG. 3 is a view showing an example of data stored in the external memory 15. The external memory 15 stores the audio data series and the phrase management information respectively corresponding to the plurality of audio phrases.

The phrase management information indicating an address at which the audio data series corresponding to the audio phrase of a phrase 0 are stored inside the external memory 15 (that is, the phrase management information of the phrase 0) is stored at an address “0x000000” of the external memory 15. Specifically, information indicating that a start address of the phrase 0 is “0x000400” and an end address thereof is “0x001FFF” is stored at the address “0x000000” as the phrase management information of the phrase 0.

The phrase management information corresponding to the audio phrase of a phrase 1 is stored at an address “0x000010” of the external memory 15. That is, information indicating that the start address of the phrase 1 is “0x002000” and the end address thereof is “0x006FFF” is stored at the address “0x000010” as the phrase management information of the phrase 1.

Similarly afterward, the start address and the end address of each audio phrase of phrases 2 to 63 are stored as the phrase management information of the phrases 2 to 63. For example, the start address and the end address of the phrase 2 are stored at the address “0x00020” of the external memory 15 as the phrase management information. The start address and the end address of the phrase 63 are stored at an address “0x0003F0” of the external memory 15 as the phrase management information.

As indicated in the phrase management information, the audio data series corresponding to the phrase 0 are continuously stored at addresses between the address “0x000400” of the external memory 15 as the start address and the address “0x001FFF” as the end address. In addition, the audio data series corresponding to the phrase 1 are continuously stored at addresses between the address “0x002000” as the start address and the address “0x006FFF” as the end address.

With reference to FIG. 2 again, the audio reproduction device 13 includes an interface circuit 21, a register 22, and a reproduction control circuit 23.

The interface circuit 21 is an interface circuit used for transmitting data when the reproduction control circuit 23 reads the audio data from the external memory 15. The interface circuit 21 is constituted of an interface circuit for serial communication, such as a serial peripheral interface (SPI), for example.

The register 22 is a storage part temporarily storing the phrase management information which is read from the external memory 15 by the reproduction control circuit 23. In the present example, the phrase management information read from the external memory 15 by the reproduction control circuit 23 is stored in the register 22.

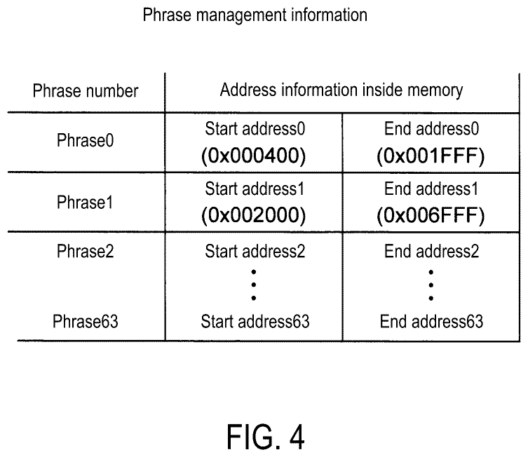

FIG. 4 is a view showing an example of the phrase management information stored in the register 22. The phrase management information corresponding to each audio phrase of the phrases 0 to 63 of the data stored in the external memory 15 shown in FIG. 3 is read from the external memory 15 by the reproduction control circuit 23 and is stored in the register 22.

The reproduction control circuit 23 reads the audio data series corresponding to the audio phrase corresponding to the vehicle velocity of the vehicle CA from the external memory 15 in response to control of the MCU 12 (illustration is omitted in FIG. 2), and reproduces audio in the order of reading on the basis of the read audio data series.

In addition, the reproduction control circuit 23 reads the phrase management information from the external memory 15 before reading the audio data series for each audio phrase. For example, the reproduction control circuit 23 reads the phrase management information during activation or immediately after activation of the audio reproduction device 13, and stores the read phrase management information in the register 22. The reproduction control circuit 23 reads the audio data series corresponding to each audio phrase from the external memory 15 with reference to the phrase management information stored in the register 22.

In the audio reproduction device 13 of the present example, the reproduction control circuit 23 reads the phrase management information corresponding to a plurality of audio phrases from the external memory 15 in advance and stores it in the register 22. Therefore, since the audio reproduction device 13 need only acquire the phrase management information with reference to the register 22 provided inside the device instead of reading the phrase management information from the external memory 15 every time the audio data series are read, even when a plurality of audio phrases is continuously reproduced, reproduction of audio can be smoothly performed.

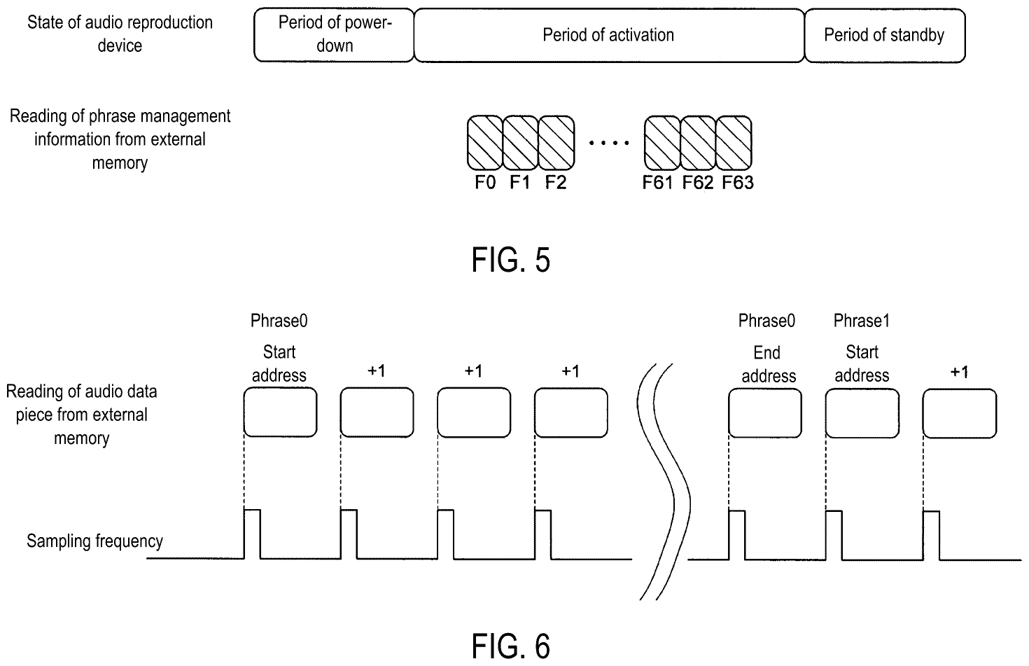

Next, processing operation of reading processing of the phrase management information executed by the audio reproduction device 13 of the present example and reading processing of the audio data series for each audio phrase will be described with reference to FIGS. 5 and 6.

FIG. 5 is a view schematically showing reading processing of the phrase management information according to the present example. The upper stage indicates a state of the audio reproduction device 13, the lower stage indicates the phrase management information read from the external memory 15.

When a power supply of the audio reproduction device 13 is turned on from a state in which the power supply of the audio reproduction device 13 is turned off (that is, a power-down state) and shifts to a state of being activated, the reproduction control circuit 23 reads the phrase management information from the external memory 15 via the interface circuit 21. At this time, the reproduction control circuit 23 continuously reads the phrase management information from the phrase 0 to the phrase 63 in sequence (indicated as F0 to F63 in the diagrams).

The reproduction control circuit 23 stores the phrase management information of the read phrases 0 to 63 in the register 22. While the audio reproduction device 13 is maintained in a standby state, the register 22 continues to hold the phrase management information.

FIG. 6 is a view schematically showing processing operation of reading processing of the audio data according to the present example. Here, reading of the audio data when the audio reproduction device 13 continuously reproduces audio of the phrase 0 and audio of the phrase 1 is described as an example.

The reproduction control circuit 23 reads the audio data series in sequence at a time interval of a sampling frequency.

That is, the reproduction control circuit 23 reads the audio data stored in the domain of the external memory 15 corresponding to the start address (0x000400) of the phrase 0 with reference to the phrase management information stored in the register 22. Thereafter, while the address (reading target) is incremented (+1), the audio data series corresponding to the phrase 0 are read in sequence. The reproduction control circuit 23 reproduces audio of the phrase 0 in the order of reading.

When the audio data series from the external memory 15 are read to the end address (0x001FFF) of the phrase 0, the reproduction control circuit 23 continues to read the audio data stored in the domain of the external memory 15 corresponding to the start address (0x002000) of the phrase 1. Thereafter, while the address (reading target) is incremented (+1), the audio data series corresponding to the phrase 1 are read in sequence. The reproduction control circuit 23 reproduces audio of the phrase 1 in the order of reading.

In this manner, in the audio reproduction device 13 of the present example, when audio of a plurality of audio phrases is continuously reproduced, after the audio data corresponding to the end address of one audio phrase is read, the audio data corresponding to the start address of a different audio phrase can be read at a timing of the next sampling frequency. Therefore, according to the audio reproduction device 13 of the present example, continuous reproduction of audio of a plurality of audio phrases can be smoothly performed.

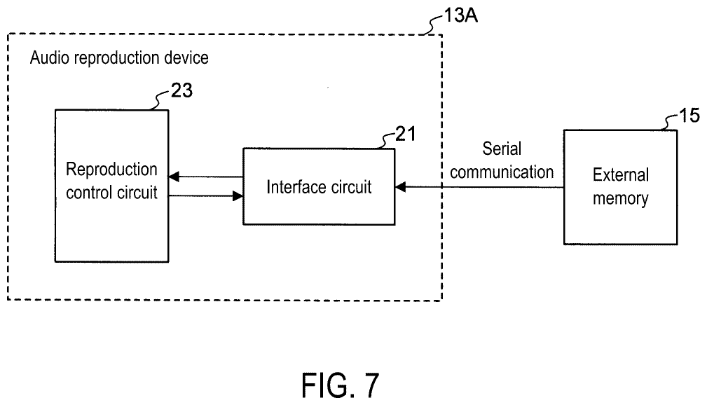

FIG. 7 is a block diagram showing an internal constitution of an audio reproduction device 13A of a comparative example which is different from the audio reproduction device 13 of the present example and has no register for storing the phrase management information.

In the audio reproduction device 13A of the comparative example, every time the reproduction control circuit 23 reads the audio data series of each audio phrase, the phrase management information corresponding to the audio phrase is read from the external memory 15.

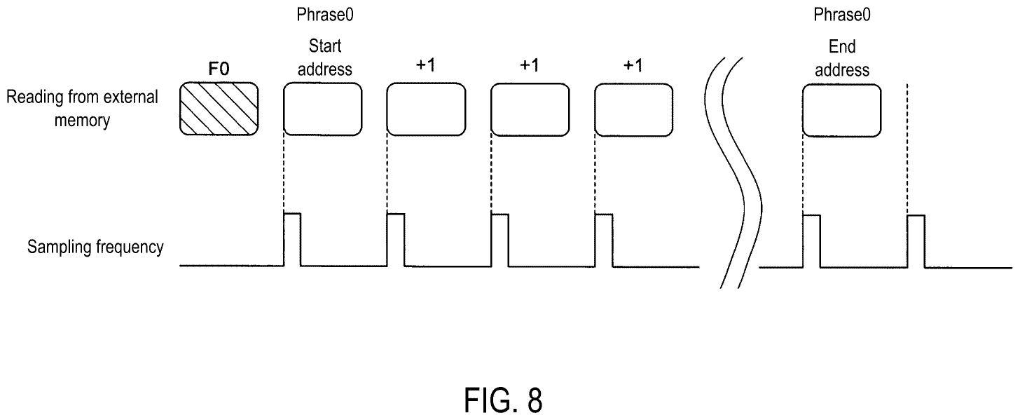

FIG. 8 is a view schematically showing reading processing of the phrase management information and the audio data series in the audio reproduction device 13A of the comparative example. Here, a case of reading the phrase management information and the audio data series corresponding to the phrase 0 is described as an example.

The reproduction control circuit 23 of the comparative example first reads the phrase management information corresponding to the phrase 0 (indicated as F0 in the diagrams) from the external memory 15 via the interface circuit 21. Further, the reproduction control circuit 23 reads the audio data series of the phrase 0 in sequence at a time interval of the sampling frequency on the basis of the information of the start address and the end address of the phrase 0 indicated in the phrase management information.

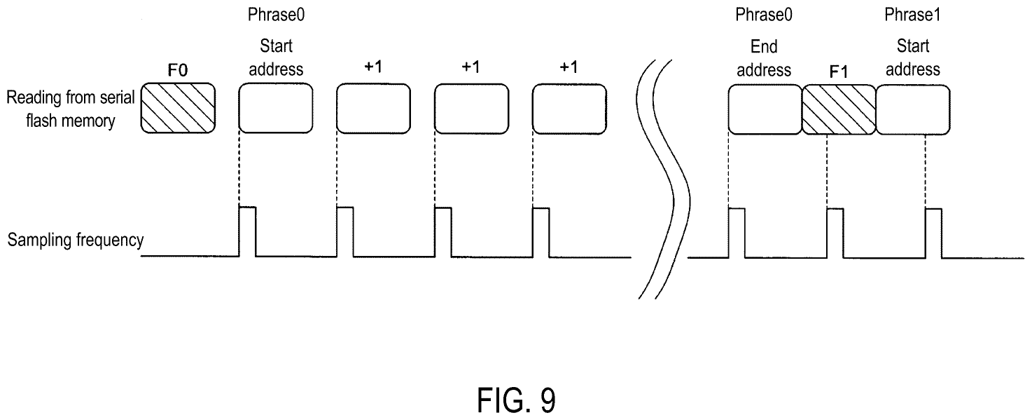

FIG. 9 is a view schematically showing reading processing of the phrase management information and the audio data series when the audio reproduction device 13A of the comparative example continuously reproduces audio of the phrase 0 and audio of the phrase 1.

The reproduction control circuit 23 of the comparative example reads the phrase management information of the phrase 1 (indicated as F1 in the diagrams) when reading of the audio data corresponding to the end address of the phrase 0 ends. Further, reading of the audio data series of the phrase 1 is started on the basis of the information of the start address of the phrase 1 indicated in the phrase management information.

In the reproduction control circuit 23 of the comparative example, after reading of the audio data series corresponding to the phrase 0 is completed, there is a need to read the management information of the phrase 1 until reading of the audio data series corresponding to the phrase 1 is started. For this reason, after the audio data corresponding to the end address of the phrase 0 is read, the audio data corresponding to the start address of the phrase 1 cannot be read in time at the timing of the next sampling frequency. Therefore, in the audio reproduction device 13A of the comparative example, continuous reproduction of audio of a plurality of audio phrases cannot be smoothly performed.

In contrast, in the audio reproduction device 13 of the present example, the reproduction control circuit 23 reads the phrase management information corresponding to the plurality of audio phrases of the phrases 0 to 63 in advance from the external memory 15 as shown in FIG. 5 and stores it in the register 22. Accordingly, in a stage in which audio is reproduced by reading the audio data series corresponding to each audio phrase, the phrase management information stored in the register 22 need only be referred to, and there is no need to read the phrase management information again from the external memory 15.

Therefore, according to the audio reproduction device 13 of the present example, continuous reproduction of audio of a plurality of audio phrases can be smoothly performed.

The disclosure is not limited to the foregoing embodiment. For example, in the foregoing examples, a case in which the reproduction control circuit 23 stores the phrase management information read from the external memory 15 in the register 22 has been described as an example. However, in place of the register 22, a constitution in which a random access memory (RAM) is provided and the phrase management information is stored in the RAM may be adopted.

In addition, in the foregoing examples, a case in which the phrase management information is read from the external memory 15 during activation of the audio reproduction device 13 has been described as an example. However, a timing of reading the phrase management information is not limited to this. For example, it need only be constituted such that at least two pieces of the phrase management information are read in advance at a timing before starting reading of the audio data series, such as immediately after activation of the audio reproduction device 13.

In addition, in the foregoing examples, a case in which the phrase management information corresponding to each audio phrase of the phrases 0 to 63 is stored in the external memory 15 and the reproduction control circuit 23 reads these via the interface circuit 21 and stores them in the register 22 has been described as an example. However, all pieces of the phrase management information stored in the external memory 15 are not necessarily read and stored in the register 22, and it need only be constituted such that the phrase management information corresponding to at least two audio phrases are read and stored in the register 22.

In addition, in each of the foregoing examples, a case in which the audio reproduction device 13 constitutes the vehicle approach notification system 100 has been described as an example. However, the constitution of the audio reproduction device of the disclosure is not limited to that mounted in a vehicle approach notification system and can be applied to all devices performing reproduction of audio having a plurality of audio phrases.

It will be apparent to those skilled in the art that various modifications and variations can be made to the disclosed embodiment without departing from the scope or spirit of the disclosure. In view of the foregoing, it is intended that the disclosure covers modifications and variations provided that they fall within the scope of the following claims and their equivalents.

What is claimed is:

1. An audio reproduction device that is connected to an external memory storing a plurality of audio data series respectively corresponding to a plurality of audio phrases and storing management information indicating an address at which each of the plurality of audio data series is stored, and performs reproduction of audio by reading the audio data series from the external memory for each audio phrase, the audio reproduction device comprising:
a serial interface performing serial communication with the external memory;
registers storing the management information corresponding to the audio data series of at least two of the audio phrases transmitted from the external memory via the serial interface; and
a reproduction control circuit reading the audio data series from the external memory via the serial interface for each audio phrase on the basis of the management information stored in the registers and reproducing audio in the order of reading the audio data series for each audio phrase.

2. The audio reproduction device according to claim 1,
wherein the reproduction control circuit is constituted to be able to continuously reproduce audio having one audio phrase and audio having a different audio phrase, and
wherein before starting reading the audio data series of at least the one audio phrase from the external memory, the management information corresponding to the audio data series of the plurality of audio phrases including the one audio phrase and the different audio phrase is read from the external memory via the serial interface and is stored in the registers.

3. The audio reproduction device according to claim 2,
wherein the reproduction control circuit reads audio data constituting the audio data series in sequence at a time interval of a sampling frequency, and
wherein in continuous reproduction of audio having the one audio phrase and audio having the different audio phrase, last reading of the audio data series of the one audio phrase and first reading of the audio data series of the different audio phrase are continuously performed at a time interval of one sampling frequency.

4. The audio reproduction device according to claim 1,
wherein the reproduction control circuit reads the management information corresponding to the audio data series of at least the two or more audio phrases from the external memory via the serial interface at a timing when the audio reproduction device is activated and stores the read management information in the registers.

5. The audio reproduction device according to claim 2,
wherein the reproduction control circuit reads the management information corresponding to the audio data series of at least the two or more audio phrases from the external memory via the serial interface at a timing when the audio reproduction device is activated and stores the read management information in the registers.

6. The audio reproduction device according to claim 3,
wherein the reproduction control circuit reads the management information corresponding to the audio data series of at least the two or more audio phrases from the external memory via the serial interface at a timing when the audio reproduction device is activated and stores the read management information in the registers.

7. An audio reproduction method executed by an audio reproduction device that is connected to an external memory storing a plurality of audio data series respectively corresponding to a plurality of audio phrases and storing management information indicating an address at which each of the plurality of audio data series is stored; and includes a serial interface performing serial communication with the external memory, registers storing data transmitted from the external memory via the serial interface, and a reproduction control circuit reading the audio data from the external memory via the serial interface for each audio phrase and reproducing audio in the order of reading the audio data for each audio phrase, the audio reproduction method comprising:
a step of reading the management information corresponding to the audio data series of at least two of the audio phrases from the external memory via the serial interface;
a step of storing the management information corresponding to the audio data series of at least the two or more of the audio phrases read from the external memory in the registers;
a step of reading the audio data series from the external memory via the serial interface for each audio phrase on the basis of the management information stored in the registers; and
a step of reproducing audio on the basis of the order of reading the audio data series for each audio phrase.
